(19) United States
(12) Patent Application Publication
(10) Pub. No.: US 2024/0187255 A1
(43) Pub. Date: Jun. 6, 2024

(54) USER-CONTROLLED LINKABILITY OF ANONYMOUS SIGNATURE SCHEMES

(71) Applicants: NEC Laboratories Europe GmbH, Heidelberg (DE); IMDEA Software Institute, Pozuelo de Alarcon (ES)

(72) Inventors: Claudio SORIENTE, Heidelberg (DE); Dario FIORE, Pozuelo de Alarcon (ES)

(21) Appl. No.: 18/277,232

(22) PCT Filed: Apr. 28, 2021
(86) PCT No.: PCT/EP2021/061196

§ 371 Date: Aug. 15, 2023

(30) Foreign Application Priority Data
Feb. 19, 2021 (EP) 21158208.5

(51) Int. Cl. H04L 9/32; H04L 9/08

(52) U.S. Cl. CPC H04L 9/3255; H04L 9/0861

(57) ABSTRACT

A method to enhance an anonymous signature scheme with user-controlled linkability includes generating, by a signer of a ring signature scheme or a group signature scheme, a signer-specific secret (x) and generating a secret key based on the generated secret (x). The signer augments a message to be signed with a message-unique value that is related to the signer-specific secret (x) thereby generating an augmented message. The signer signs the augmented message with the secret key of the signer and produces a proof that an arbitrary set of signed messages embed the signer-specific secret (x). The signer anonymously publishes the produced proof for verification by a third-party verifier.

### CROSS REFERENCE TO RELATED APPLICATIONS

This application is a U.S. National Phase application under 35 U.S.C. § 371 of International Application No. PCT/EP2021/061196, filed on Apr. 28, 2021, and claims benefit to European Patent Application No. EP 21158208.5, filed on Feb. 19, 2021. The International Application was published in English on Aug. 25, 2022 as WO 2022/174933 A1 under PCT Article 21(2).

### FIELD

The present invention relates to a method for enhancing an anonymous signature scheme with user-controlled linkability as well as to a network device configured to act as a signer in an anonymous signature scheme.

### BACKGROUND

Anonymous signature schemes (i.e., ring signatures and group signatures) allow parties to produce signatures that are publicly verifiable but that keep the anonymity of the signer, within a set of potential signers. In particular, ring signatures allow a party to produce signatures on behalf of a group, called “ring”, of potential signers chosen ad-hoc, while the signature does not reveal the signer within the ring. Similarly, group signatures allow a group manager to define group members so that each group member can sign messages on behalf of the group. Signatures are publicly verifiable, but do not disclose the actual signer. In a nutshell, the anonymity set for a group signature is the set of all group members as admitted by the group manager, whereas the anonymity set for a ring signature is the set of public keys included in the ring that is arbitrarily chosen by the signer at the moment of producing the signature.

However, neither ring signatures nor group signatures allow a signer to prove that it has produced an arbitrary set of signatures. In particular, given a set of ring (or group) signatures (σ₁, σ₂, . . . , σₙ) produced by Alice, no current scheme allows Alice to prove that she has produced all of them.

### SUMMARY

In an embodiment, the present disclosure provides a method for enhancing an anonymous signature scheme with user-controlled linkability, the method comprising: generating, by a signer of a ring signature scheme or a group signature scheme, a signer-specific secret (x) and generating a secret key based on the generated secret (x); augmenting, by the signer, a message to be signed with a message-unique value that is related to the signer-specific secret (x) thereby generating an augmented message; signing, by the signer, the augmented message with the secret key of the signer; producing, by the signer, a proof that an arbitrary set of signed messages embed the signer-specific secret (x); and anonymously publishing, by the signer, the produced proof for verification by a third-party verifier.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a mechanism for implementing user-controlled linkability in a ring signature scheme in accordance with an embodiment of the present invention;

FIG. 2 is a schematic view illustrating a mechanism for implementing user-controlled linkability in a group signature scheme in accordance with an embodiment of the present invention;

FIG. 3 is a schematic view illustrating the implementation of a signature scheme enhanced with user-controlled linkability in a blockchain application scenario in accordance with an embodiment of the present invention; and

FIG. 4 is a schematic view illustrating the implementation of a signature scheme enhanced with user-controlled linkability in a smart city application scenario in accordance with an embodiment of the present invention.

### DETAILED DESCRIPTION

In an embodiment, the present invention improves and further develops ring signatures schemes and group signature schemes in such a way that a party can prove that any subset of its signatures where produced by the same entity, without revealing its identity.

In an embodiment, the present invention provides a method for enhancing an anonymous signature scheme with user-controlled linkability, the method comprising: generating, by a signer of a ring signature scheme or a group signature scheme, a signer-specific secret x and generating a secret key based on the generated secret x; augmenting, by the signer, a message to be signed with a message-unique value that is related to the secret x thereby generating an augmented message; signing, by the signer, the augmented message with the signer's secret key; producing, by the signer, a proof that an arbitrary set of signed messages embed the same signer-specific secret x; and anonymously publishing, by the signer, the produced proof for verification by a third-party verifier.

In an embodiment, the present invention provides a network device configured to act as a signer in an anonymous signature scheme, the network device comprising a processor and a memory, the memory comprising processor executable instructions that, when executed by the processor, cause the processor to perform the following operations for enhancing the anonymous signature scheme with user-controlled linkability: generating a signer-specific secret x and generating a secret key based on the generated secret x; augmenting a message to be signed with a message-unique value that is related to the secret x thereby generating an augmented message; signing the augmented message with the signer's secret key; producing a proof that an arbitrary set of signed messages embed the same signer-specific secret x; and anonymously publishing the produced proof for verification by a third-party verifier.

Embodiments of the present invention allow a party to prove authorship of any subset of its signatures, without revealing its identity. In other words, a signer can prove that any subset of its signatures are “linked”. As such, embodiments of the invention find natural application in scenarios where anonymous signature schemes are used to strike a balance between anonymity and authentication.

The current invention has direct application in IoT, blockchain, and TEE scenarios. For instance, in IoT applications, like smart-cities applications, embodiments of the current invention may be used to control privacy of reported measurements and to allow users to link measurements produced by their devices, e.g., for personalized statistics or offers. Similarly, some blockchain technologies use ring signatures to ensure the anonymity of parties issuing transactions. Embodiments of the present invention may enable a party to arbitrary select a set of transaction it produced, and to prove to a verifier that indeed all of those transactions where produced (i.e., signed) by the same party.

According to an embodiment of the invention, it may be provided that the signer generates a key-pair used for signing messages, wherein the key-pair includes the secret key based on the selected secret x and a public key. The public key of the key-pair may be published via the communication network used for anonymous communication within the signature scheme.

According to an embodiment, the signing of an arbitrary message by a signer may include the steps of choosing an arbitrary ring or group of public keys to protect the signer's identity, and anonymously publishing the generated signature along with the signed message and the ring or group of public keys used to sign the message.

According to an embodiment, the signing of an arbitrary message m by a signer may include the steps of generating a tuple including the message m to be signed, a message-unique parameter g and an additional parameter β that ties the message to be signed to the signer-specific secret x. The idea is to include in each message to be signed a value that is unique per message and related to the secret x that is fixed at key generation. Hence, when the signer wants to sign message m, he rather signs the tuple (m, β, g).

According to an embodiment, it may be provided that the message-unique parameter g is chosen randomly, wherein the chosen parameter g serves as a generator of a finite cyclic group G. The parameter β may be determined to be calculated as β=g^{x}.

According to an embodiment, the signer-specific secret x may be generated by using a cryptographic hash function H. The hash function H may be defined as H( ): {0,1}*→Z_{q}, where q denotes the order of the finite cyclic group G, and wherein the signer-specific secret x is picked randomly from Z_{q}.

According to an embodiment, it may be provided that verifying a proof produced by a signer with regard to the linkage of a specific set of signatures comprises checking whether the discrete log of the respective parameters β with respect to the respective parameters g is the same for all signatures of the specific set of signatures. For instance, proving that a signature al on a message (m₁, β₁, g₁) and a signature σ2 on a message (m₂, β₂, g₂) have actually been issued by the same party, may be done by issuing a proof of knowledge that the discrete log of β₁, with respect to gi equals the discrete log of β₂ with respect to σ₂ (which, basically, is a proof that β₁ and β₂ have the same “x” at the exponent).

According to an embodiment, it may be provided that verifying a proof produced by a signer with regard to the linkage of a specific set of signatures comprises checking the validity of each signature of the set of signatures; and, if all signatures of the set of signatures and the proof are valid, determining the signatures of the specific set of signatures to be valid signatures issued by the same party.

According to an embodiment of the invention, a signature scheme enhanced with a user-controlled linkability mechanism may be leveraged to provide additional functionality to a distributed ledger (e.g., blockchain) application scenario. For instance, it may be provided that, having made a determination that the signatures of a specific set of signed user registration transactions at a blockchain that pertain to different identities used by a user with different service providers are valid signatures issued by the same user, may be used as a necessary condition for transferring a user asset between the service providers.

According to an embodiment of the invention, a signature scheme enhanced with a user-controlled linkability mechanism may be leveraged to provide additional functionality to an IoT (e.g., smart city) application scenario. For instance, it may be provided that, having made a determination that the signatures of a specific set of measurement reports of IoT devices towards a service provider are valid signatures issued by the same party, may be used as a necessary condition for providing the party targeted offers from the service provider. Alternatively, the proof that the signatures of a specific set of measurement reports of IoT devices towards a service provider are valid signatures issued by the same party may be used as a basis for generating personalized statistics.

There are several ways how to design and further develop the teaching of the present invention in an advantageous way. To this end it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

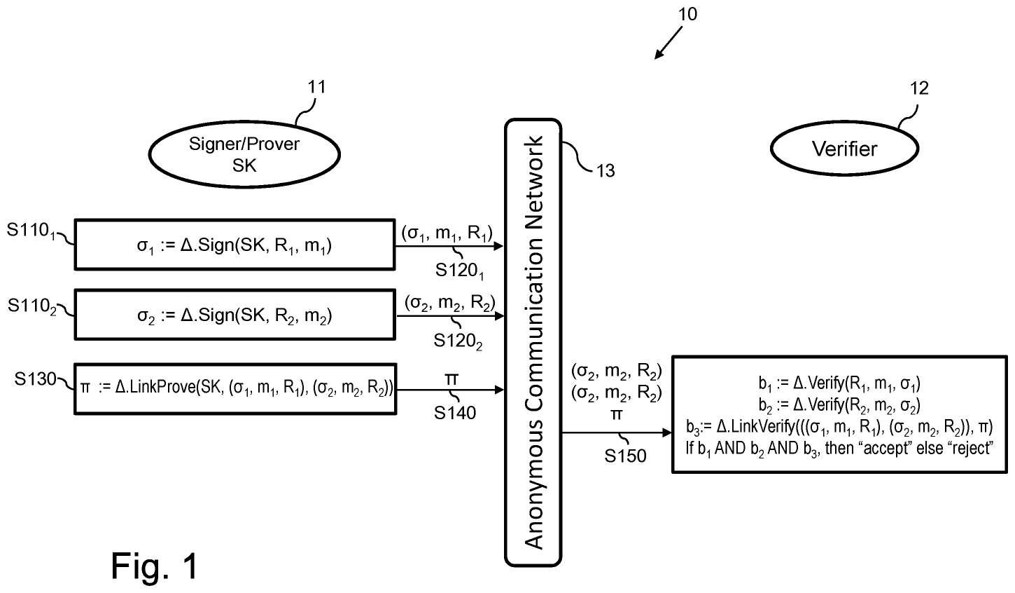

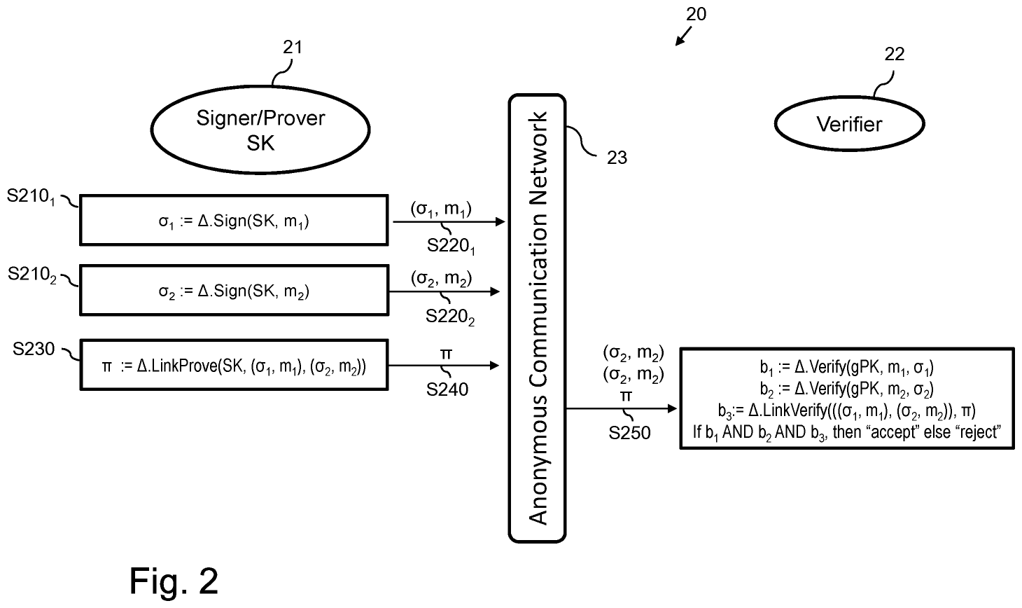

Embodiments of the present invention apply to anonymous signature schemes, in particular ring signatures or group signatures, and allow parties of the signature scheme to sign messages such that signatures are publicly verifiable, while at the same time hiding the identity of the signer within a set of potential signers. FIG. 1 illustrates an embodiment of the present invention in the context of a ring signature scheme, while FIG. 2 illustrates an embodiment of the invention in the context of a group signature scheme.

Before describing details of embodiments of the invention with reference to FIG. 1, first, an overview of general aspects of conventional prior art ring signature schemes will be provided hereinafter.

Generally, a ring signature scheme Θ is a tuple of algorithms that can be defined as follows:
(SK, PK):=KeyGen(1^{k}). This is a key generation algorithm that, upon input of a security parameter k, outputs a secret key SK and a public key PK.
σ:=Sign(SK, R, m). This is a signing algorithm that, upon input of a secret key SK, a set (also called “ring”) of public keys R (of size ≥2), and a message m, outputs a signature G.
{I/O}:=Verify(R, m, σ). This is a verification algorithm that, upon input of a set of public keys R, a message m, and a signature σ, outputs either 1 (i.e., “valid”) or 0 (i.e., “invalid”).

Informally, a ring signature scheme Θ is correct if, for any positive integer n, for any {(SKᵢ, PKᵢ)}_{i∈[n]}, where each (SKᵢ, PKᵢ) is output by an execution of KeyGen(1^{k}), any j∈[n], and any message m, it holds that Verify(R, m, Sign(SKⱼ, R, m))=1, where R is an arbitrary subset of the public keys in {(SKᵢ, PKᵢ)}_{i∈[n]} that includes PKⱼ.

Informally, a ring signature scheme Θ is anonymous if, given a signature σ computed on an arbitrary ring of public keys R (of size ≥2) and an arbitrary message m, an adversary cannot tell which secret key was used to produce a, among all of the secret keys corresponding to the public keys in R.

Informally, a ring signature scheme Θ is unlinkable, if given two signatures σᵢ, σⱼ, an adversary cannot tell whether they were generated by the same signer.

Informally, a ring signature scheme Θ is unforgeable if an adversary cannot produce a valid signature σ computed on an arbitrary ring of public keys R and an arbitrary message m, unless it knows the secret key corresponding to one of the public keys in R, or unless one honest user holding the secret key corresponding to one of the public keys in R has previously output a signature on the same message and the same ring.

Embodiments of the present invention add user-controlled linkability to ring signature schemes as described above. In this context, the invention aims at allowing a party to prove that any two or more of its (ring) signatures were actually produced by the same party, without revealing its identity.

Given a ring signature scheme Θ as introduced above, i.e. with algorithms (KeyGen, Sign, Verify), embodiments of the present invention provide a ring signature scheme with user-controlled linkability Δ with algorithms (KeyGen, Sign, Verify, LinkProve, LinkVerify) as follows. In the notation used below, G denotes a finite cyclic group where the discrete logarithm assumption holds and q denotes the order of G. Further, HO: {0,1}*→Z_{q} denotes a cryptographic hash function.

Δ.KeyGen(1^{k})
Compute (SK′, PK′):=Θ.KeyGen(1^{k})
Pick x at random from Z_{q}
Set SK:=(SK′, x) and PK:=PK′
Output (SK′, PK′)

Δ.Sign(SK, R, m)
Parse SK as (SK′, x)
Pick a random g, generator of G
Compute β:=g^{X}
Set m′:=(m, β, g)
Compute α:=Θ.Sign(SK′, R, m′)
Output σ=(α, β, g)

Δ.Verify(R, m, a)
Parse σ as (α, β, g)
Set m′:=(m, β, g)
Output Θ.Verify(R, m′, α)

Δ.LinkProve(SK, (σ₁,m₁, R₁), . . . , (σₙ, Mₙ, Rₙ))
Parse SK as (x, SK′)
Parse σᵢ as (σᵢ, βᵢ, gᵢ) for i∈[n]
Compute sᵢ=H(m₁, mₙ, i) for i∈[n]
Compute h=Π_{i=1 . . . n}gᵢ^{s}^{ᵢ}
Pick r at random from Z_{q} and set t:=h^{r}
Compute c:=H(σ₁, . . . , σₙ, m₁, . . . , Mₙ, R₁, . . . , Rₙ, t)
Compute z:=r+x:c
Output π=(t, z)

Δ.LinkVerify(((σ₁, m₁, R₁), . . . , (σₙ, Mₙ, Rₙ)), π)
Parse π as (t, z)
Parse σi as (σi, βi, gᵢ) for i∈[n]
Compute sᵢ=H(m₁, . . . , mₙ, i) for i∈[n]
Compute h=Π_{i=1 . . . n}gᵢ^{s}^{ᵢ}
Compute β=Π_{i=1 . . . n}βi ^{s}^{ᵢ}
Compute c:=H(σ₁, . . . , σₙ, m₁, . . . , Mₙ, R₁, . . . , Rₙ, t)
If h^{z}=t·β^{c}, then output 1; else output 0.

Compared to a ring/group signature scheme without user-controlled likability, by applying the above algorithms the size of the signature is increased by one element in Z_{q} and one element in G.

FIG. 1 illustrates a mechanism for implementing user-controlled linkability in a ring signature scheme 10 in accordance with an embodiment of the present invention. The mechanism will be described based on the algorithms introduced above, although it will be appreciated by those skilled in the art that these algorithms are just exemplary and that the concrete implementation of the algorithms may differ from the specifications given above.

In the context of the scenario shown in FIG. 1, it is assumed that the signer/prover 11 and the verifier 12 communicate via an anonymous communication network 13. It should be noted that without this assumption, anonymity—as may be required by ring signatures—would not stand.

First, although not shown in FIG. 1, the signer/prover 11 computes a key-pair by

running algorithm Δ.KeyGen, as specified above. The public key is published via the communication network 13, e.g., on a public cloud or on a distributed ledger. From that point on, the signer/prover 11 can sign arbitrary messages by choosing arbitrary rings of public keys to protect its identity. The signing procedure may be executed by running algorithm Δ.Sign, as specified above, which is exemplarily shown in FIG. 1 for a first signature σ₁ at step S110₁ and for a second signature σ₂ at step S110₂. The signatures σᵢ, along with the signed messages mi and the rings Rᵢ, used to sign, are published anonymously via the communication network 13, as shown at steps S120₁ and S120₂.

At some point, the signer/prover 11 wishes to prove to a verifier 12 that any subset of the signatures it produced were produced by the same party, without revealing its identity. In particular, in the scenario of FIG. 1, it is assumed that the signer/prover 11 wishes to prove that the signatures σ₁ and σ₂ were produced by the same party. To do so it, the signer/prover 11 runs Δ.LinkProve and produces a proof π, as is shown at step S130. The proof π is also published anonymously via the communication network 13, as is shown at steps S140.

On the other side, as is shown at steps S150, the verifier 12 first checks the validity of each signature, i.e. σ₁ and σ₂ in the illustrated scenario, by running Δ.Verify on each of them. In addition, the verifier 12 checks the proof 7C by running Δ.LinkVerify. If all signatures and the proof are valid, the verifier 12 concludes that σ₁ and σ₂ are two valid signatures issued by the same party.

FIG. 2 illustrates an embodiment of the present invention in connection with a group signature scheme. Generally, a group signature scheme is a digital signature scheme with anonymity provisions that are similar to the ones of a ring signature scheme. In particular, in a group signature scheme, there is a group manager that sets up the system and publishes the group public key. The group manager also admits parties to join the group by providing them signing keys. After joining the group, each party can sign messages on behalf of the group, so that a signature is publicly verifiable using the group public key, but it protects the anonymity of the actual signer among all members of the group.

Generally, a group signature scheme may include the following algorithms:
(gSK, uSK₁, . . . , uSKₙ, gPK):=KeyGen(1^{k}). This is a key generation algorithm that, upon input of a security parameter k, outputs a secret key gSK for the group manager, n user secret keys, and a group public key gPK. User secret keys are securely distributed to members of the group, whereas the group public key is made public.
σ:=Sign(uSK, m). This is a signing algorithm that, upon input of a user secret key uSK and a message m, outputs a signature σ.
{1/0}:=Verify(gPK, m, σ). This is a verification algorithm that, upon input of the group public key gPK, a message m, and a signature σ, outputs either 1 (i.e., “valid”) or 0 (i.e., “invalid”). Informally, Γ is correct if, for any positive integer n, for any set of keys (gSK, uSK₁, . . . , uSKₙ, gPK) output by KeyGen(1^{k}), any j□[n], and any message m, we have Verify(gPK, m, Sign(uSKⱼ, m))=1.

Informally, F is anonymous if, given a signature σ computed on a message m, an adversary cannot tell which secret key was used to produce σ, among (uSK₁, . . . , uSKₙ).

Informally, F is unlinkable, if given two signatures, an adversary cannot tell whether they were generated by the same signer.

Informally, F is unforgeable if an adversary cannot produce a valid signature σ computed on an arbitrary message m, unless it knows a secret key uSKⱼ, j∈[n], or unless one honest group member has previously output a signature on the same message and the same ring.

It should be noted that the above description defines static groups (i.e., groups whose member signing keys are defined by the group manager via KeyGen. Some group signature schemes, however, allow for dynamic groups where the member signing key is output by an interactive Join protocol between an issuer and a perspective member. Furthermore, group signature schemes allow the group manager or another designated party to “open” a signature, i.e., to de-anonymize the signer of a specific signature. In accordance with embodiments of the present invention, the technology described herein can be used to provide user-controlled linkability to any group signature scheme regardless of whether the group definition is static or dynamic and regardless of the opening functionality.

Embodiments of the present invention add user-controlled linkability to group signature schemes as described above. In this context, the invention aims at allowing a party to prove that any two or more of its group signatures were actually produced by the same party, without revealing its identity.

Given a group signature scheme Γ as introduced above, i.e. with algorithms (KeyGen, Sign, Verify), embodiments of the present invention provide a group signature scheme with user-controlled linkability Δ with algorithms (KeyGen, uKeyGen, Sign, Verify, LinkProve, LinkVerify) as follows. In the notation used below, G denotes a finite cyclic group where the discrete logarithm assumption holds and q denotes the order of G. Further, H( ): {0,1}*→Z_{q} denotes a cryptographic hash function.

Δ.KeyGen(1^{k})
Compute (gSK, uSK₁, . . . , uSKₙ, gPK):=Γ.KeyGen(1k)
Output (gSK, uSK₁, . . . , uSKₙ, gPK)

Δ.uKeyGen(uSK, 1^{k})
Pick x at random from Z_{q}
Set SK:=(uSK, x)
Output (SK)

Δ.Sign(SK, m)
Parse SK as (uSK, x)
Pick a random g, generator of G
Compute β:=g^{X}
Set m′:=(m, β, g)
Compute α:=Γ.Sign(uSK, m′)
Output σ=(α, β, g)

Δ.Verify(gPK, m, σ)
Parse σ as (α, β, g)
Set m′:=(m, β, g)
Output Γ Verify(gPK, m′, σ)

Δ.LinkProve(SK, (σ₁,m₁), . . . , (σₙ, Mₙ))
Parse SK as (uSK, x)
Parse σᵢ as (αᵢ, βᵢ, gᵢ) for i∈[n]
Compute sᵢ=H(m₁, . . . , mₙ, i) for i∈[n]
Compute h=Π_{i=1 . . . n}gᵢ^{s}^{ᵢ}
Pick r at random from Z_{q} and set t:=h^{r}
Compute c:=H(σ₁, . . . , σₙ, m₁, . . . , Mₙ, t)
Compute z:=r+x c
Output π=(t, z)

Δ.LinkVerify(((σ₁, m₁), . . . , (σn, Mₙ)), π)
Parse π as (t, z)
Parse σᵢ as (σᵢ, βᵢ, gᵢ) for i∈[n]
Compute sᵢ=H(m₁, . . . , mₙ, i) for i∈[n]
Compute h=Π_{i=1 . . . n}gᵢ^{s}^{ᵢ}
Compute β=Π_{i=1 . . . n}βᵢ^{s}^{ᵢ}
Compute c:=H(σ₁, . . . , σₙ, m₁, . . . , Mₙ, t)
If h^{z}=t. β^{c}, then output 1; else output 0.

FIG. 2 illustrates a mechanism for implementing user-controlled linkability in a group signature scheme 20 in accordance with an embodiment of the present invention. The mechanism will be described based on the algorithms introduced above, although it will be appreciated by those skilled in the art that these algorithms are just exemplary and that the concrete implementation of the algorithms may differ from the specifications given above.

A group manager (not shown in FIG. 2) defines public and secret keys, e.g., by running Δ.KeyGen as introduced above. While the group public key will be published, e.g., on a public cloud or on a distributed ledger, each member secret key is securely transferred to the respective group member. Next, each group member uses the received secret key to generate their own user-specific secret keys, e.g. by running Δ.uKeyGen.

Specifically, FIG. 2 shows how group members sign messages and prove linkability in accordance with embodiments of the present invention. It is assumed that the signer/prover 21 and the verifier 22 communicate with each other via an anonymous communication network 23. It should be noted that without this assumption, anonymity—as may be required by group signatures—would not stand.

The signing of arbitrary messages may be executed by running algorithm Δ. Sign, as specified above, which is exemplarily shown in FIG. 2 for a first signature σ₁ at step S210₁ and for a second signature σ₂ at step S210₂. The signatures σᵢ, along with the signed messages mi are published anonymously via the communication network 13, as shown at steps S220₁ and S220₂.

At some point, the signer/prover 21 wishes to prove to a verifier 22 that any subset of the signatures it produced were produced by the same party, without revealing its identity. In particular, in the scenario of FIG. 2, it is assumed that the signer/prover 21 wishes to prove that the signatures σ₁ and σ₂ were produced by the same party. To do so it, the signer/prover 11 runs Δ.LinkProve and produces a proof π, as is shown at step S230. The proof π is also published anonymously via the communication network 23, as is shown at steps S240.

On the other side, as is shown at steps S250, the verifier 22 first checks the validity of each signature, i.e. σ₁ and σ₂ in the illustrated scenario, for instance by running Δ.Verify on each of them. In addition, the verifier 22 checks the proof π, e.g. by running Δ.LinkVerify. If all signatures and the proof are valid, the verifier 22 concludes that σ₁ and σ₂ are two valid signatures issued by the same party.

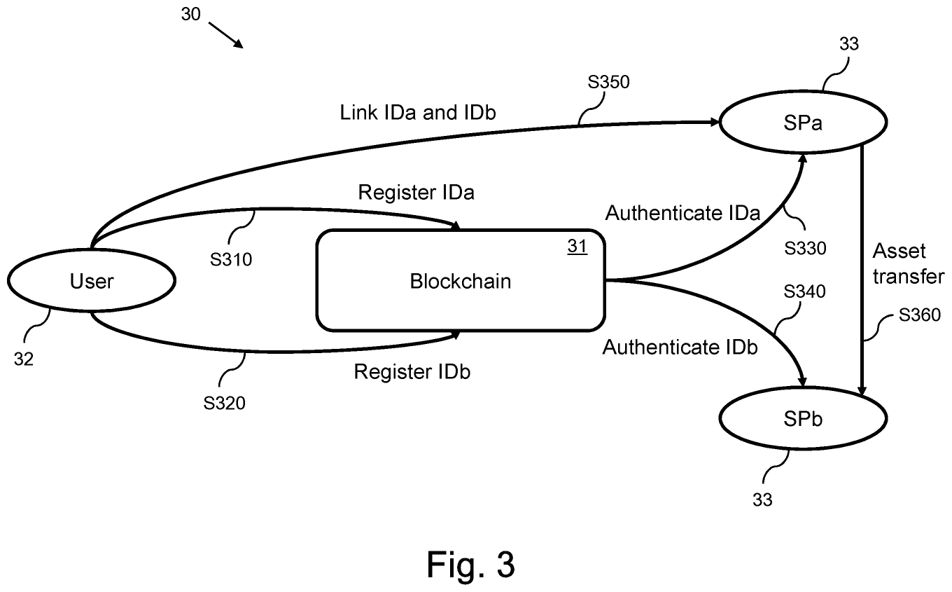

According to an embodiment of the invention, a user-controlled linkability mechanism may be implemented in the context of distributed ledger systems. In this regard, FIG. 3 illustrates a possible use-case where the current invention is leveraged to provide additional functionality to a blockchain application scenario 30. More specifically, FIG. 3 shows a blockchain 31 used for identity management where users 32 register their identities and service providers 33, denoted SPa and SPb in FIG. 3, leverage the blockchain 31 to authenticate users 32.

A user may have multiple identities to be used with different service providers. For example, as shown in FIG. 3, user 32 uses identity IDa with service provider SPa and identity IDb with service provider SPb. Identity registration is carried out by issuing a transaction to the blockchain 31, as illustrated for the first identity IDa of the user 32 at step S310 and for the second identity IDb of the user 32 at step S320.

According to an embodiment of the invention, each of the identity registration transactions is signed with a group or ring signature so to ensure that it was issued by a legitimate user 32, while preserving her identity. The service providers 33 may act as verifiers by checking the validity of the signatures, e.g. by running the Δ.Verify routine described above, thereby authenticating the user's identities IDa and IDb. For service provider SPa, this authentication is illustrated at step S330 and, correspondingly, for service provider SPb at step S340.

At a later stage, that same user 32 may wish to transfer assets from her account on SPa to her account on SPb. To do so, the user 32 may execute user-controlled mechanisms for achieving linkability of anonymous signatures in accordance with embodiments of the present invention. Specifically, such mechanisms may be used to link the user's 32 two identities, as shown at step S350, i.e., to show that IDa and IDb belong to the same user 32. For instance, this can be performed by the user 32 by running the Δ.LinkProve routine described above. On the other hand, the service providers SPa and SPb may run the Δ.LinkVerify routine described above. In case this routine is successful, SPa and SPb may consider the asset transfer as legitimate and may grant the request, i.e. the asset transfer is executed as shown at step S360.

According to an embodiment, the present invention provides a method for transferring an asset of a user 32 from one service provider SPa to another service provider SPb using blockchain technology, wherein the user 32 and the service providers 33 are member of a ring signature or group signature scheme. The user 32 registers her identities, which she uses with the service providers 33, at a blockchain 31 by means of respective registration transactions. Each registration transaction includes a user-specific secret and is signed by the user 32. The signed registration transactions (as well as the respective public key, the signature itself and the rings used for signing) are published on the blockchain 31.

For initiating an asset transfer from the first service provider SPa to the second service provider SPb, the user 32 produces a proof that the signed registration transactions pertaining to the user's 32 identities used with the first and the second service provider SPa, SPb embed the same user-specific secret. The user 32 may either anonymously publish this proof on the blockchain 31, or the user 32 may anonymously transmit the proof, directly or indirectly, to at least one of the first and second service providers SPa, SPb for verification. In case the verification of the proof is successful, the service providers SPa, SPb can be sure that the registered identities belong to the same user 32 and the asset transfer can be executed (since considered as legitimate). On the other hand, in case the verification of the proof fails, the service providers SPa, SPb become aware that the registered identities do not belong to the same user 32 and can therefore deny the request.

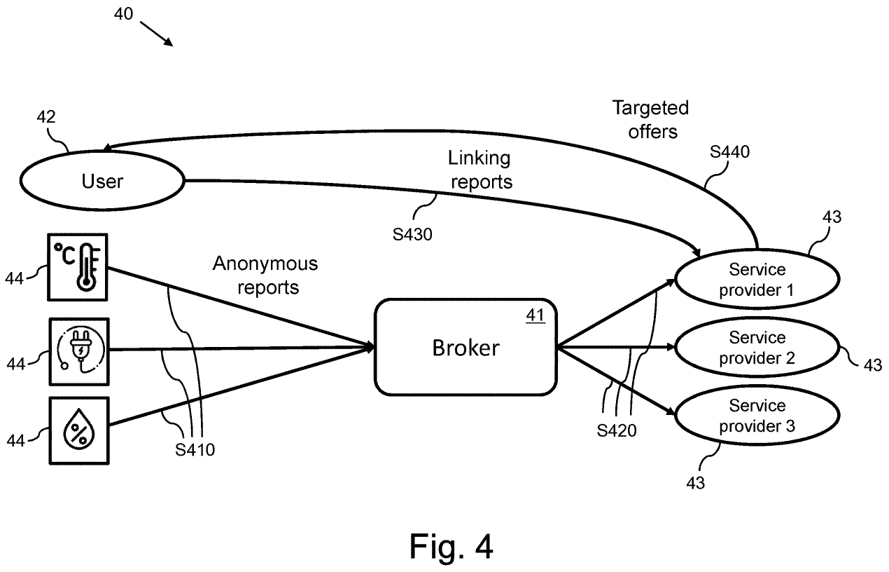

According to another embodiment of the invention, a user-controlled linkability mechanism may be implemented in the context of a smart city or IoT application. In this regard, FIG. 4 illustrates a possible use-case in a smart city application scenario 40, where a plurality of devices 44 (being under control of or belonging to a user 42) provides measurements from different sensors (e.g., humidity, temperature, electricity consumption, etc.) via a broker 41, so that multiple service providers 43 and other stakeholders can compute statistics over reported data. The broker 41 is in charge of distributing the measurement reports to corresponding service providers 43. For instance, as is shown at steps S420, the broker 41 may be configured to forward incoming temperature measurements to service provider 1, incoming electricity consumption measurements to service provider 2, etc.

The anonymous reports transmitted to the broker 41, as is shown at steps S410, may be signed with a group or ring signature scheme so to ensure that reports are authentic while preserving the anonymity of the respective device 44. Report authenticity provides service providers 43 with greater assurance of the quality of the reports, as reporting fraudulent measurements may require a valid signing key. Report anonymity may incentivize reporting by users who may not agree to share their data if reports where not anonymous. Further, service providers 43 may provide targeted offers to participating users.

At a later stage, a user 42 may wish to link some of the measurements of its sensors/devices 44 to, e.g., obtain targeted offers on, e.g., electricity plans by a specific service provider 43. To do so, the user 42 may execute user-controlled mechanisms for achieving linkability of anonymous signatures in accordance with embodiments of the present invention. Specifically, such mechanisms may be used to link the user's 42 different measurement reports, as shown at step S430, i.e., to show that the different reports (as shown at S410) belong to the same user 42. For instance, this can be performed by the user 42 by running the Δ.LinkProve routine described above. On the other hand, the respective one of the service providers 43 may run the Δ.LinkVerify routine described above. In case this routine is successful, the service provider 43 may consider the user 42 as legitimate and may provide the targeted offers to the user 42, as shown at step S440.

By using an anonymous signature scheme with a user-controlled linkability mechanism in accordance with embodiments of the present invention, it can be achieved that the proof of linkage across reports does not reveal any identity, i.e. the user 42 can still preserve her anonymity. Only if the user 42 wishes to accept the offer of a service provider 43, she may reveal her identity to, e.g., sign a respective contract.

According to an embodiment, the present invention provides a method for anonymously linking measurement reports of sensors/devices 44 being under the control of a user 42, wherein the measurement reports are transmitted to a broker 41 for further distribution to a plurality of service providers 43. The user 42 and the service providers 43 are assumed to be members of a ring signature or group signature scheme.

The user 42 transmits the measurements of her devices 44 to the broker 41 by means of respective anonymous reports, as shown at S410. Each report includes, in addition to the measurement, a user-specific secret. Each report, i.e. the measurement together with the user-specific secret (and possibly further information, depending on the specific implementation) is signed by the user 42. The respective public key, the signatures, the rings used for signing as well as the signed reports are made publicly available within the communication network over which the user 42 and the service providers 43 communicate with each other.

When the user 42 wishes to link some of the measurements of its sensors/devices 44 to, e.g., obtain targeted offers from a specific service provider 43, the user 42 may produce a proof that the signed reports pertaining to the respective measurement embed the same user-specific secret. The user 42 may either anonymously publish this proof via the underlying communication network, or the user 42 may anonymously transmit the proof, directly or indirectly, to the respective one of the service providers 43 for verification. In case the verification of the proof is successful, the service provider 43 can be sure that the respective measurement reports origin from the same user 42, and the user 42 can be granted access to targeted offer, as is shown at S440. On the other hand, failure of the verification demonstrates that the respective measurement reports have not been transmitted by the same user 42, and the service provider 43 can therefore deny the targeted offer.

With regard to a still further application scenario, it is noted that trusted execution environments (TEE) use group signatures in remote attestation protocols to protect the identity of the TEE being attested. In DRM (Digital Rights Management) applications that use TEEs, a client may be tasked to prove that it consumed a specific set of DRM-protected content. To do so, the client may execute user-controlled mechanisms for achieving linkability of anonymous signatures in accordance with embodiments of the present invention. A concrete implementation may use (with respective adaptations) the principles described above in connection with the blockchain and smart city application scenarios.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for enhancing an anonymous signature scheme with user-controlled linkability, the method comprising:
generating, by a signer of a ring signature scheme or a group signature scheme, a signer-specific secret (x) and generating a secret key based on the generated secret (x);
augmenting, by the signer, a message to be signed with a message-unique value that is related to the signer-specific secret (x) thereby generating an augmented message;
signing, by the signer, the augmented message with the secret key of the signer;
producing, by the signer, a proof that an arbitrary set of signed messages embed the same specific secret (x); and
anonymously publishing, by the signer, the produced proof for verification by a third-party verifier.

2. The method according to claim 1, further comprising:
generating, by the signer, a key-pair used for signing messages, the key-pair including the secret key based on the generated secret and a public key; and
publishing the public key of the key-pair via the communication network used for anonymous communication within the signature scheme.

3. The method according to claim 1, wherein the signing of an arbitrary message by the signer comprises:
choosing an arbitrary ring or group of public keys to protect an identity of the signer; and
anonymously publishing a generated signature along with a signed message and the arbitrary ring or group of public keys used to sign the message.

4. The method according to claim 1, wherein the signing of an arbitrary message by the signer comprises:
generating a tuple including the message to be signed, a message-unique parameter (g) and an additional parameter (β) that ties the message to be signed to the signer-specific secret (x); and
signing the tuple.

5. The method according to claim 4, wherein the message-unique parameter (g) is chosen randomly, and wherein the message-unique parameter (g) serves as a generator of a finite cyclic group (G).

6. The method according to claim 4, wherein additional parameter (β) is determined to be calculated as β=g^{x}.

7. The method according to claim 1, wherein the signer-specific secret (x) is generated using a cryptographic hash function (H).

8. The method according to claim 7, wherein the cryptographic hash function (H) is defined as HO: {0,1} *→*Z_{q}, where q denotes the order of the finite cyclic group (G), and wherein the signer-specific secret (x) is picked randomly from Z_{q}.

9. The method according to claim 4, wherein verifying a proof produced by a signer with regard to the linkage of a specific set of signatures comprises:
checking whether the discrete log of the respective parameters (β) with respect to the respective parameters (g) is the same for all signatures of the specific set of signatures.

10. The method according to claim 1, wherein verifying a proof produced by a signer with regard to the linkage of a specific set of signatures comprises:
checking the validity of each signature of the specific set of signatures; and
if all signatures of the specific set of signatures and the proof are valid, determining the signatures of the specific set of signatures to be valid signatures issued by a same party.

11. The method according to claim 1, wherein a determination that the signatures of a specific set of signed user registration transactions at a blockchain that pertain to different identities used by a user with different service providers are valid signatures issued by the same user is used as a necessary condition for transferring a user asset between the service providers.

12. The method according to claim 10, wherein a determination that the signatures of a specific set of measurement reports of IoT devices towards a service provider are valid signatures issued by the same party is used as a necessary condition for providing the party targeted offers from the service provider.

13. A network device configured to act as a signer in an anonymous signature scheme, the network device comprising a processor and a memory, the memory comprising processor executable instructions that, when executed by the processor, cause the processor to perform the following operations for enhancing the anonymous signature scheme with user-controlled linkability:
generating a signer-specific secret (x) and generating a secret key based on the generated secret (x);
augmenting a message to be signed with a message-unique value that is related to the signer-specific secret (x) thereby generating an augmented message;
signing the augmented message with the secret key of the signer;
producing a proof that an arbitrary set of signed messages embed the signer-specific secret (x); and
anonymously publishing the produced proof for verification by a third-party verifier.

14. The network device according to claim 13, wherein the signing of an arbitrary message comprises:
generating a tuple including the message to be signed, a message-unique parameter (g) and an additional parameter (β) that ties the message to be signed to the signer-specific secret (x); and
signing the tuple.

15. The network device according to claim 14, wherein the message-unique parameter (g) is chosen randomly, wherein the chosen parameter (g) serves as a generator of a finite cyclic group and wherein the additional parameter (β) is determined to be calculated as β=g^{x}.
